(19) United States
(12) Patent Application Publication
(10) Pub. No.: US 2026/0046690 A1
(43) Pub. Date: Feb. 12, 2026

(54) METHOD AND APPARATUS FOR PROCESSING PROTOCOL DATA UNITS

(71) Applicant: ELECTRONICS AND TELECOMMUNICATIONS RESEARCH INSTITUTE, Daejeon (KR)

(72) Inventors: Namsuk LEE, Daejeon (KR); Hee Sang CHUNG, Daejeon (KR); Yong Seouk CHOI, Daejeon (KR)

(21) Appl. No.: 19/279,448

(22) Filed: Jul. 24, 2025

(30) Foreign Application Priority Data
Jul. 28, 2024 (KR) 10-2024-0099508
Jul. 22, 2025 (KR) 10-2025-0099231

(51) Int. Cl. H04W 28/06; H04W 28/02

(52) U.S. Cl. CPC H04W 28/06; H04W 28/0268

(57) ABSTRACT

A method of a base station may comprise: receiving protocol data units (PDUs) from a user plane function (UPF) entity; transmitting a first PDU belonging to the PDUs to a terminal; receiving a status report associated with the first PDU from the terminal; and discarding one or more PDUs belonging to a PDU set group including the first PDU based on the status report.

### CROSS-REFERENCE TO RELATED APPLICATIONS

This application claims priority to Korean Patent Applications No. 10-2024-0099508, filed on Jul. 26, 2024, and No. 10-2025-0099231, filed on Jul. 22, 2025, with the Korean Intellectual Property Office (KIPO), the entire contents of which are hereby incorporated by reference.

### BACKGROUND

### 1. Technical Field

The present disclosure relates to a technique for processing protocol data units, and more particularly, to a technique for discarding all protocol data units included in a protocol data unit set when a decoding failure is predicted for a frame.

### 2. Related Art

A communication network (e.g. 5G communication network, 6G communication network, and the like) for providing improved communication services compared to an existing communication network (e.g. long term evolution (LTE), LTE Advanced (LTE-A), and the like) is being developed. The 5G communication network (e.g. new radio (NR) communication network) can support frequency bands of 6 GHz or lower as well as frequency bands above 6 GHz. In other words, the 5G communication network can support frequency range 1 (FR1) and/or frequency range 2 (FR2). The 5G communication network can support various communication services and scenarios compared to the LTE communication network. For example, usage scenarios of the 5G communication network may include enhanced Mobile Broadband (eMBB), Ultra-Reliable Low Latency Communication (URLLC), and massive Machine Type Communication (mMTC).

Extended reality (XR) may be a general term referring to extended reality that combines reality and a virtual world. XR technology may be used to implement XR. XR may include virtual reality (VR), augmented reality (AR), and mixed reality (MR). The 5G communication network and the 6G communication network can support services based on XR technology (hereinafter referred to as ‘XR services’).

Traffic for supporting XR services (hereinafter referred to as ‘XR traffic’) may be large-volume traffic. The XR traffic may be distinguished by application data units (ADUs), each of which is a unit of information distinguishable at an application layer level. The ADU may be divided into protocol data unit (PDU) sets. The moving picture experts group (MPEG) standard video compression technology may be applied to the XR traffic (e.g. video traffic). When the MPEG standard video compression technology is applied, a PDU set may be configured with one I frame, one B frame, or one P frame. A group of pictures (GOP) may be a unit used for compressing and transmitting a video in the MPEG standard video compression technology. Each GOP may include multiple frames (e.g. I frame, B frame, or P frame).

In a GOP, when at least one PDU included in a PDU set associated with an I frame is lost, a problem may occur. For example, when one PDU is lost, decoding of the remaining frames included in the GOP may fail, and the decoding failure may cause waste of radio resources between a base station and a terminal.

### SUMMARY

The present disclosure for resolving the above-described problems is directed to providing a method and an apparatus for processing protocol data units.

According to a first exemplary embodiment of the present disclosure, a method of a base station may comprise: receiving protocol data units (PDUs) from a user plane function (UPF) entity; transmitting a first PDU belonging to the PDUs to a terminal; receiving a status report associated with the first PDU from the terminal; and discarding one or more PDUs belonging to a PDU set group including the first PDU based on the status report.

The method may further comprise: transmitting packet data convergence protocol (PDCP) configuration information to the terminal before receiving the PDUs, wherein the PDCP configuration information may include at least one of: configuration information of a loss timer used for determining whether a PDU is lost or information indicating a discard operation based on a PDU set group.

A header belonging to each of the PDUs may include PDU set information, and the PDU set information may include at least one of: identification information for each PDU set group to which each of the PDUs belongs, a dependency parameter of each of the PDUs, identification information for each PDU set to which each of the PDUs belongs, or information on a sequence number of each of the PDUs.

The PDCP configuration information may be transmitted through a radio resource control (RRC) reconfiguration message, and a header of the first PDU may include information on a sequence number of the first PDU.

The status report may include at least one of information on a sequence number of the first PDU or information indicating loss of the first PDU.

The discarding of the one or more PDUs may comprise: determining loss of the first PDU based on the status report; determining whether to discard the first PDU based on a dependency parameter of the lost first PDU; and discarding the one or more PDUs based on a result of the determining of whether to discard the first PDU.

Transmission of the status report according to expiration of the loss timer may be configured for the terminal by the PDCP configuration information.

According to a second exemplary embodiment of the present disclosure, a method of a terminal may comprise: receiving packet data convergence protocol (PDCP) configuration information from a base station; after receiving the configuration information, receiving a first protocol data unit (PDU) from the base station; starting a loss timer configured by the PDCP configuration information, based on determining that a second PDU associated with a sequence number smaller than a sequence number of the first PDU has not been received; and transmitting a status report including the sequence number of the second PDU to the base station according to expiration of the loss timer.

The PDCP configuration information may include at least one of: configuration information of the loss timer or information indicating a discard operation based on a PDU set group.

The method may further comprise: performing a monitoring operation for receiving the second PDU during a time configured by the loss timer after starting the loss timer, wherein the loss timer expires based on a result of the monitoring operation.

The terminal may be configured by the PDCP configuration information to transmit the status report according to expiration of the loss timer.

According to a third exemplary embodiment of the present disclosure, a base station may comprise at least one processor, and the at least one processor may cause the base station to perform: receiving protocol data units (PDUs) from a user plane function (UPF) entity; transmitting a first PDU belonging to the PDUs to a terminal; receiving a status report associated with the first PDU from the terminal; and discarding one or more PDUs belonging to a PDU set group including the first PDU based on the status report.

The at least one processor may further cause the base station to perform: transmitting packet data convergence protocol (PDCP) configuration information to the terminal before receiving the PDUs, wherein the PDCP configuration information may include at least one of: configuration information of a loss timer used for determining whether a PDU is lost or information indicating a discard operation based on a PDU set group.

A header belonging to each of the PDUs may include PDU set information, and the PDU set information may include at least one of: identification information for each PDU set group to which each of the PDUs belongs, a dependency parameter of each of the PDUs, identification information for each PDU set to which each of the PDUs belongs, or information on a sequence number of each of the PDUs.

The PDCP configuration information may be transmitted through a radio resource control (RRC) reconfiguration message, and a header of the first PDU may include information on a sequence number of the first PDU.

The status report may include at least one of information on a sequence number of the first PDU or information indicating loss of the first PDU.

In the discarding of the one or more PDUs, the at least one processor may cause the base station to perform: determining loss of the first PDU based on the status report; determining whether to discard the first PDU based on a dependency parameter of the lost first PDU; and discarding the one or more PDUs based on a result of the determining of whether to discard the first PDU.

Transmission of the status report according to expiration of the loss timer may be configured for the terminal by the PDCP configuration information.

According to the present disclosure, filtering may be performed on packets generated in an upper layer (e.g. application layer) of a terminal. The terminal may set a group sequence number for a PDU set through packet filtering, and may set dependency parameters for PDUs belonging to the PDU set. A PDCP entity of the terminal may receive information of a PDU set sequence number, dependency parameters, and service data adaptation protocol (SDAP) PDUs from an upper layer (e.g. SDAP entity). The PDCP entity of the terminal may generate PDCP PDUs based on PDCP SDUs during a time configured by a discard timer after operating the discard timer. Upon expiration of the discard timer, the PDCP entity of the terminal may discard a PDCP SDU and may identify a dependency parameter of the discarded PDCP SDU. The PDCP entity of the terminal may discard PDCP SDUs, among PDCP SDUs received after reception of the discarded PDCP SDU, that correspond to the same PDU set group sequence number as the discarded PDCP SDU, based on a dependency parameter of the discarded PDCP SDU. Accordingly, the terminal can prevent waste of radio resources by discarding PDCP SDUs configuring frames for which decoding is expected to fail.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating exemplary embodiments of a format of protocol data unit (PDU) set information.

FIG. 4 is a conceptual diagram illustrating exemplary embodiments of a quality of service (QoS) model.

FIG. 5 is a conceptual diagram illustrating exemplary embodiments of PDU sets to which GTP-U extension headers are added.

FIG. 6 is a conceptual diagram illustrating exemplary embodiments of PDU sets to which GTP-U extension headers are added.

FIG. 7 is a conceptual diagram illustrating exemplary embodiments of a format of PDU set information.

FIG. 8 is a conceptual diagram illustrating exemplary embodiments of PDU sets to which GTP-U extension headers are added.

FIG. 9 is a conceptual diagram illustrating exemplary embodiments of PDU sets to which GTP-U extension headers are added.

FIG. 10 is a sequence chart illustrating exemplary embodiments of a PDU discarding procedure by a base station.

FIG. 11 is a sequence chart illustrating exemplary embodiments of an SDU discarding procedure by a terminal.

### DETAILED DESCRIPTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re)transmission’ may refer to ‘transmission’, ‘retransmission’, or ‘transmission and retransmission’, ‘(re)configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication network (or communication system) to which exemplary embodiments according to the present disclosure are applied will be described. The communication network to which exemplary embodiments according to the present disclosure are applied is not limited to the content described below, and the exemplary embodiments according to the present disclosure can be applied to various communication networks. Here, the term ‘communication network’ may be used interchangeably with ‘communication system’. The communication network may refer to a wireless communication network, and the communication system may refer to a wireless communication system.

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, signaling may be at least one of System Information (SI) signaling (e.g. transmission of System Information Block (SIB) and/or Master Information Block (MIB)), RRC signaling (e.g. transmission of RRC parameters and/or higher-layer parameters), MAC Control Element (CE) signaling, or PHY signaling (e.g. transmission of Downlink Control Information (DCI), Uplink Control Information (UCI), and/or Sidelink Control Information (SCI).

The names of frames proposed in the present disclosure may be generalized as a first frame, a second frame, a third frame, and the like. In the present disclosure, a transmission time may refer to a start time of frame transmission and/or an end time (e.g. completion time) of frame transmission, while a reception time may refer to a start time of frame reception and/or an end time (e.g. completion time) of frame reception. The term ‘time’ may be interpreted as a time point depending on a context.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

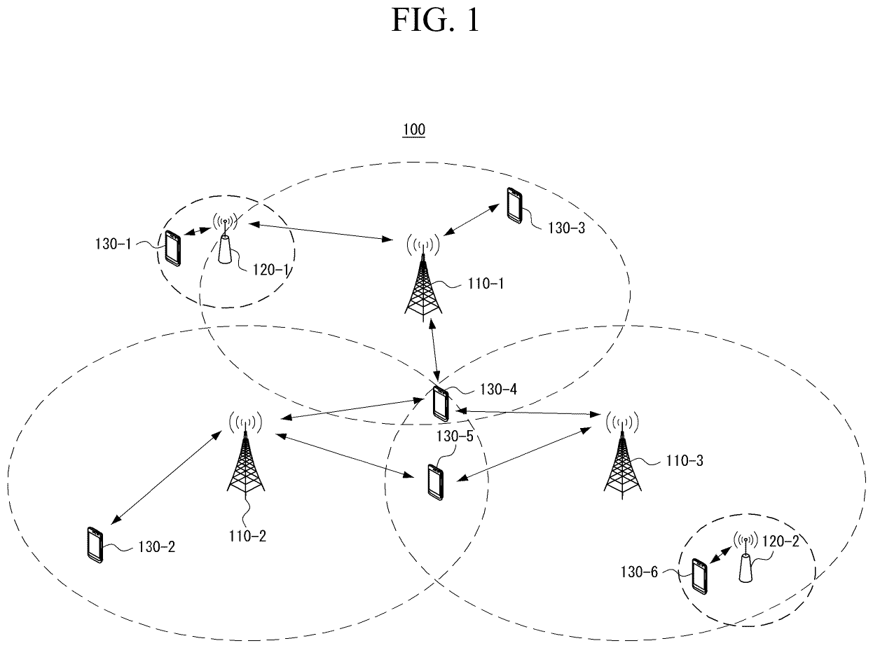

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

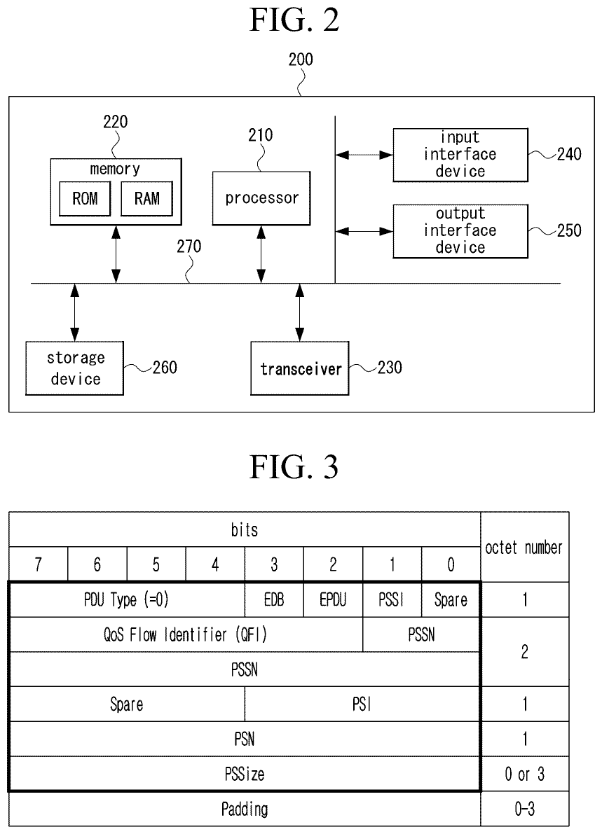

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multi-hop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication network will be described. Even when a method (e.g. transmission or reception of a signal) to be performed at a first communication node among communication nodes is described, a corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

FIG. 3 is a conceptual diagram illustrating exemplary embodiments of a format of protocol data unit (PDU) set information.

Referring to FIG. 3, PDU set information used for a quality of service (QoS) guarantee mechanism reflecting characteristics of data for supporting extended reality (XR) is illustrated. A PDU set may be a set including one or more PDUs. The PDU set information may be meta information for the PDU set. The PDU set information may be transmitted by a user plane function (UPF) entity to a base station. Alternatively, the PDU set information may be transmitted by a central unit (CU) of the base station to a distributed unit (DU) of the base station.

The PDU set information may be transmitted through each PDU to which a header (e.g. general packet radio service tunneling protocol (GTP)-U header or GTP-U extension header) including the PDU set information belongs. A PDU may be transmitted as part of a PDU set together with other PDUs. Alternatively, the PDU set information may be transmitted to the base station from a core network entity (e.g. access management function (AMF) entity) through control signaling (e.g. next generation application protocol (NGAP) signaling) before a PDU set associated with the PDU set information is transmitted.

The PDU set information may include fields (or information elements) for the PDU set. The PDU set information may include meta information for the PDUs or the PDU set. The meta information may include at least one of information on a PDU type, information (e.g. end of data burst, EDB) indicating termination of a data burst (e.g. end of a frame), information (e.g. end of PDU set, EPDU) indicating whether a current PDU is the last PDU of the PDU set, information (e.g. PDU set size indicator, PSSI) indicating presence of information indicating a total size of all PDUs belonging to the PDU set to which the current PDU belongs (hereinafter referred to as ‘PDU set size’), information (e.g. PDU set size, PSSize) indicating the size of the PDU set, identification information (e.g. QoS flow identifier, QFI) of a QoS flow to which the current PDU belongs, information (e.g. PDU set sequence number, PSSN) on a sequence number of the PDU set to which the current PDU belongs, or information on a sequence number of the current PDU within the PDU set (e.g. PDU sequence number within the PDU set, PSN) to which the current PDU belongs.

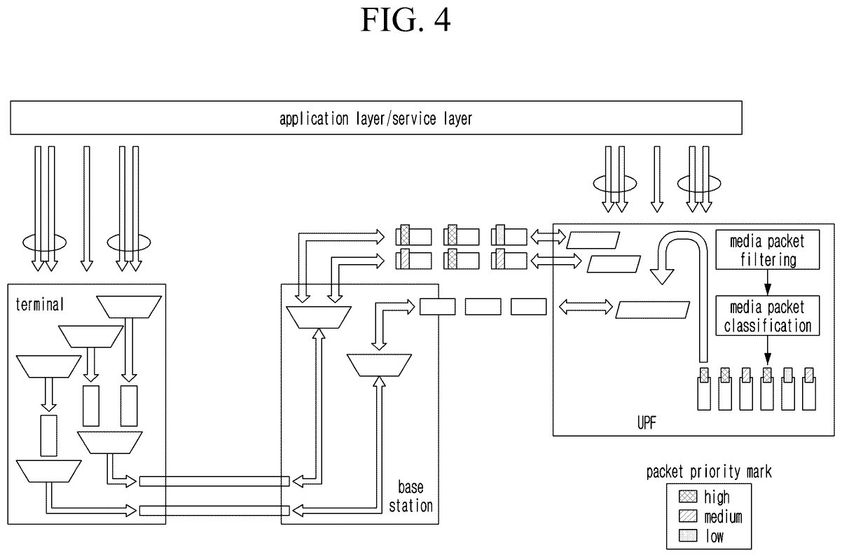

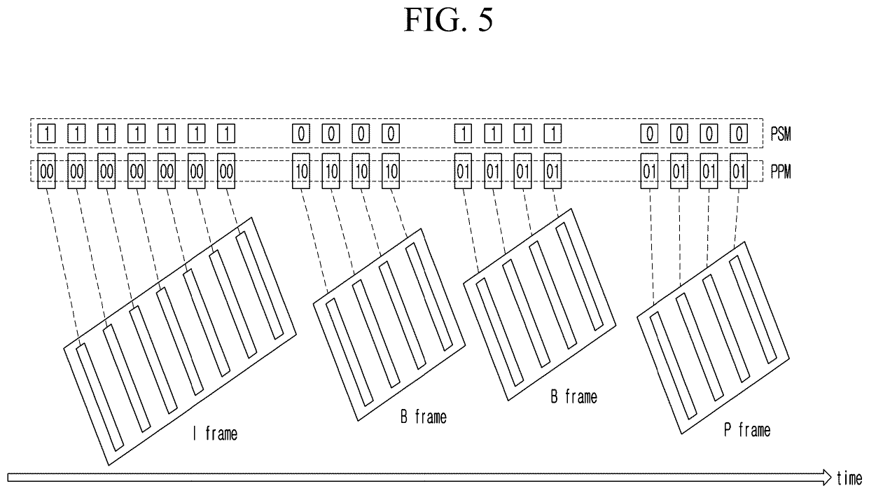

FIG. 4 is a conceptual diagram illustrating exemplary embodiments of a quality of service (QoS) model.

Referring to FIG. 4, data packets (e.g. XR data or streaming data) may be generated in an application layer or a service layer. The generated data packets may be delivered to a terminal or a UPF entity. In the present disclosure, ‘packet’ and ‘PDU’ may be used with the same meaning.

After receiving the data packets from the application layer or the service layer, the terminal may map uplink data packets to QoS flows according to a QoS rule. The terminal may mark (or, allocate or attach) the same QFI on data packets mapped to the same QoS flow. When establishing a PDU session, the terminal may mark (or, allocate or attach) a packet priority mark (PPM) on each of the packets according to a PPM rule received at the terminal. The PPM rule may be defined by an application function (AF). The defined PPM rule may be delivered to a core network entity. The AF may deliver, through signaling, specific criteria for classifying packets or specific criteria for determining importance of packets to the core network entity.

When receiving PDUs, the terminal may perform a monitoring operation to detect a start of a new PDU set based on a real-time transport protocol (RTP) header, an RTP extension header, or a network abstraction layer (NAL) unit header. The terminal may detect a start of a new PDU set according to a result of the monitoring operation. When a start of a new PDU set is detected, the terminal may mark (or, allocate or attach) a new packet sequence mark (PSM) on each of packets when marking the PPMs. Accordingly, PDUs belonging to the same PDU set may include the same PSM. A header (e.g. GTP-U header, GTP-U extension header, or GTP-U sub-header) of each of the PDUs may include at least one of information on the PPM or information on the PSM.

After receiving the data packets from the application layer or the service layer, the UPF entity may perform filtering on the data packets based on a 3-tuple. The 3-tuple may include a source IP address (e.g. server address), a destination IP address (e.g. terminal address), and a port protocol (e.g. transmission control protocol (TCP), user datagram protocol (UDP), or RTP). Through the filtering, media PDUs (e.g. XR packets, video packets, or audio packets) among the data packets may be identified. PDUs that are not media PDUs may bypass the filtering.

The UPF entity may classify the media PDUs based on a 5-tuple. The 5-tuple may include an RTP payload NAL, an RTP extension header, an IP flow label, a differentiated services code point (DSCP), and a port. The UPF entity may mark (or, allocate or attach) a PPM on each of the media PDUs based on at least one of an RTP header, RTP extension header, RTP payload header information, or NAL unit header identifying importance of each of the received packets. For example, it may be confirmed through the NAL unit header that a current PDU belongs to an I frame. When it is confirmed that the current PDU belongs to an I frame, a PPM indicating the highest importance may be marked on the current PDU. By marking the PPM on each of the media PDUs, the UPF entity may classify the media PDUs. Information on the PPM on each of the media PDUs may be included in a header (e.g. GTP-U header, GTP-U sub-header, or GTP-U extension header) of each of the media PDUs.

When receiving PDUs, the UPF entity may perform a monitoring operation to detect a start of a new PDU set based on an RTP header or an RTP extension header. The UPF entity may detect a start of a new PDU set according to a result of the monitoring operation. When a start of a new PDU set is detected, the UPF entity may mark (or, allocate or attach) a new PSM on each of the packets when marking PPMs. Accordingly, PDUs belonging to the same PDU set may include the same PSM. A header (e.g. GTP-U extension header, GTP-U header, or GTP-U sub-header) of each of the PDUs may include at least one of information on the PPM or information on the PSM.

FIG. 5 is a conceptual diagram illustrating exemplary embodiments of PDU sets to which GTP-U extension headers are added.

Referring to FIG. 5, an I frame, B frames, and a P frame are illustrated. A brief description on the I frame, the B frames, and the P frame is provided below. Types of XR traffic may be various. XR traffic may be distinguished by application data units (ADUs), each of which is a unit of information distinguishable in the application layer. An ADU may correspond to one photograph, one frame of a video, or one unit of audio. An ADU may be distinguished on a PDU set basis. A PDU set may include one or more PDUs.

When video traffic is compressed according to an MPEG standard, one PDU set may correspond to one I frame, one B frame, or one P frame. An I frame may be an independent frame. The I frame may include information on one complete photograph or one frame of a video regardless of presence of other frames. A P frame may include change information referencing an I frame or a P frame previously generated (or transmitted). A B frame may include change information referencing an I frame and a P frame previously and subsequently generated (or transmitted).

A group of pictures (GOP) may be a structural unit used when compressing or transmitting video. A GOP may include one or more frames. A GOP may sequentially include a GOP header and one or more frames. The GOP header may notify an entity receiving the GOP of a start of the GOP. When a video is transmitted, the video may be transmitted as a GOP.

Decoding independent of other frames may be possible based on an I frame. The I frame may include entire data on one image (or video frame). Therefore, the I frame may be the first frame among a plurality of frames included in the GOP. The I frame may function as a basis of decoding of other frames. When the I frame is lost, restoration of the video through a P frame may not be possible. When the I frame is lost, restoration of the video through B frame(s) may not be possible. The P frame may be decoded by referencing an I frame or a P frame previously generated. When the P frame is lost, decoding of a frame generated after the P frame may not be possible. However, when the P frame is corrupted, some data among lost data may be restored based on presence of an I frame previously generated. B frames may be decoded by referencing an I frame or a P frame generated previously and subsequently.

The UPF entity may identify the I frame, B frames, and P frame through packet filtering according to the exemplary embodiments illustrated in FIG. 4. The UPF entity may derive (or, generate or acquire) PDU set information according to the exemplary embodiments illustrated in FIG. 3 by identifying the I frame, B frames, and P frame. The derived PDU set information may be mapped to a QoS flow. The PDU set information mapped to the QoS flow may be transmitted to the base station.

Referring to FIG. 5, a GOP including one I frame, two B frames, and one P frame is illustrated. Each of the frames may include one or more PDUs. Each of the frames may correspond to one PDU set. A PPM and/or PSM may be marked (or, allocated or attached) on each of the PDUs belonging to the PDU set. The PSM marked on the PDUs belonging to the I frame may be 1. The PPM marked on the PDUs belonging to the I frame may be 00. The PSM marked on the PDUs belonging to the B frame may be 0. The PPM marked on the PDUs belonging to the B frame may be 10. The PSM marked on the PDUs belonging to the P frame may be 1. The PPM marked on the PDUs belonging to the P frame may be 01.

The PPM 00 may indicate the highest importance. The PPM 10 may indicate medium importance. The PPM 01 may indicate the lowest importance. The PPM 11 may indicate that the importance is reserved. When the PSM changes from 1 to 0, the terminal or the UPF entity may detect that a received PDU set has changed. When the PSM changes from 0 to 1, the terminal or the UPF entity may detect that a received PDU set has changed.

When at least one PDU associated with the I frame is lost, decoding of the I frame may not be possible. When decoding of the I frame is not possible, decoding of the B frames and the P frame referencing the I frame may also not be possible. Therefore, when at least one PDU associated with the I frame is lost, decoding of the entire GOP to which the I frame belongs may not be possible. Therefore, when at least one PDU associated with the I frame is lost, decoding failure of the entire GOP may be expected.

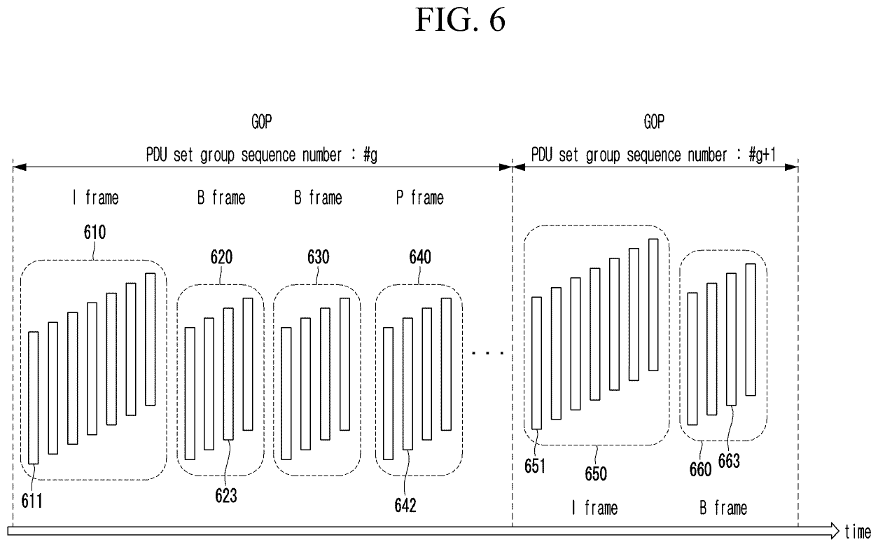

FIG. 6 is a conceptual diagram illustrating exemplary embodiments of PDU sets to which GTP-U extension headers are added.

Referring to FIG. 6, the first GOP may include four PDU sets 610, 620, 630, and 640, and the four PDU sets may be an I frame, a B frame, a B frame, and a P frame, respectively. A PDU set group including the four PDU sets 610, 620, 630, and 640 may be allocated a PDU set group sequence number #g. The first PDU 611 belonging to the I frame 610 may be allocated a dependency parameter having a value of 0. The third PDU 623 belonging to the B frame 620 may be allocated a dependency parameter having a value of 1. The second PDU 642 belonging to the P frame may be allocated a dependency parameter having a value of 1.

The second GOP may include two PDU sets 650 and 660. The two PDU sets may be an I frame and a B frame, respectively. A PDU set group including the two PDU sets 650 and 660 may be allocated a PDU set group sequence number #g+1. The first PDU 651 belonging to the I frame 650 may be allocated a dependency parameter having a value of 0. The third PDU belonging to the B frame 660 may be allocated a dependency parameter having a value of 1. A procedure for allocating the dependency parameter and the PDU set sequence group number by the UPF entity is described below. The procedure of allocating the dependency parameter and the PDU set sequence group number by the UPF entity may be based on the media packet filtering and media packet classification procedure by the UPF entity according to the exemplary embodiments illustrated in FIG. 4.

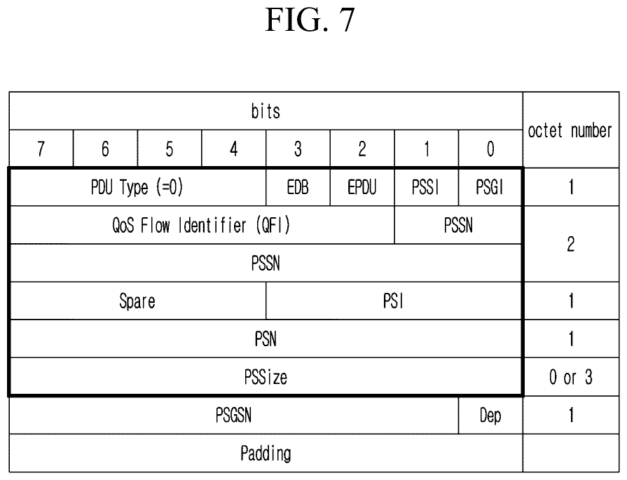

FIG. 7 is a conceptual diagram illustrating exemplary embodiments of a format of PDU set information.

The UPF entity may perform packet filtering or packet classification on packets received from the application layer or the service layer. The UPF entity may identify PDUs belonging to a PDU set through at least one of the packet filtering or the packet classification. In other words, the UPF entity may add marks to a header (e.g. GTP-U headers, GTP-U extension headers, or GTP-U sub-headers) of each of the PDUs based on at least one of an RTP header, an RTP payload, an RTP extension header, or a NAL unit header. The UPF entity may generate PDU set information by adding marks to GTP-U headers of the PDUs. The PDU set information may include information elements according to the exemplary embodiments illustrated in FIG. 3.

The UPF entity may generate the PDU set information including additional information elements other than the information elements according to the exemplary embodiments illustrated in FIG. 3. The additional information elements are described below. The UPF entity may identify a type of a frame to which a received PDU belongs based on at least one of a NAL unit header or an RTP payload header of the received PDU. When the type of the frame to which the received PDU belongs is an I frame, the UPF entity may add (or, attach or set) a dependency parameter having a value of 0 (i.e. dependency=0) to a GTP-U header of the received PDU. The dependency parameter may indicate whether independent decoding of the frame to which the packet belongs is possible. When the type of the frame to which the received PDU belongs is a B frame or a P frame, the UPF entity may add a dependency parameter having a value of 1 (i.e. dependency=1) to the GTP-U header of the received PDU. In other words, the UPF entity may add (or, attach or set) a dependency parameter having a value of 0 or 1 to a header of each of the received PDUs based on at least one of a NAL unit header or an RTP payload header of each of the received PDUs.

The UPF entity may receive GOPs from the application layer or the service layer. The UPF entity may identify (or detect) a start of a received GOP based on at least one of reception of a GOP header or reception of an I frame. The UPF entity may identify a boundary between GOPs by identifying the start of the GOP. By identifying the boundary between GOPs, the UPF entity may identify PDU set groups belonging to one GOP. The UPF entity may allocate a PDU set group sequence number to the PDU sets belonging to one GOP. That is, one GOP may be allocated one PDU set sequence number. PDU set groups belonging to different GOPs may be allocated different PDU set sequence numbers.

Referring to FIG. 7, a structure or format of PDU set information generated by the UPF entity is illustrated. The PDU set information according to exemplary embodiments illustrated in FIG. 7 may include, in addition to the information elements included in the PDU set information according to the exemplary embodiments illustrated in FIG. 3, a dependency parameter (Dep), a PDU set group sequence number, an information element (PSGI) indicating presence of the dependency parameter, and/or an information element (PSGSN) on the PDU set group sequence number.

The UPF entity may transmit PDUs including GTP-U headers including the PDU set information to the base station through a QoS flow associated with each of the PDUs. The base station may receive the PDUs including the GTP-U header including the PDU set information from the UPF entity. A lower layer of the base station (e.g. PDCP layer) may extract the PDU set information from the GTP-U header of the received PDUs. The base station may identify the information elements according to the exemplary embodiments illustrated in FIG. 3 and the information elements according to the exemplary embodiments illustrated in FIG. 7 for each of the PDUs through extraction of the PDU set information. After extracting the PDU set information, the PDCP layer of the base station may deliver SDAP SDUs to an SDAP layer of the base station.

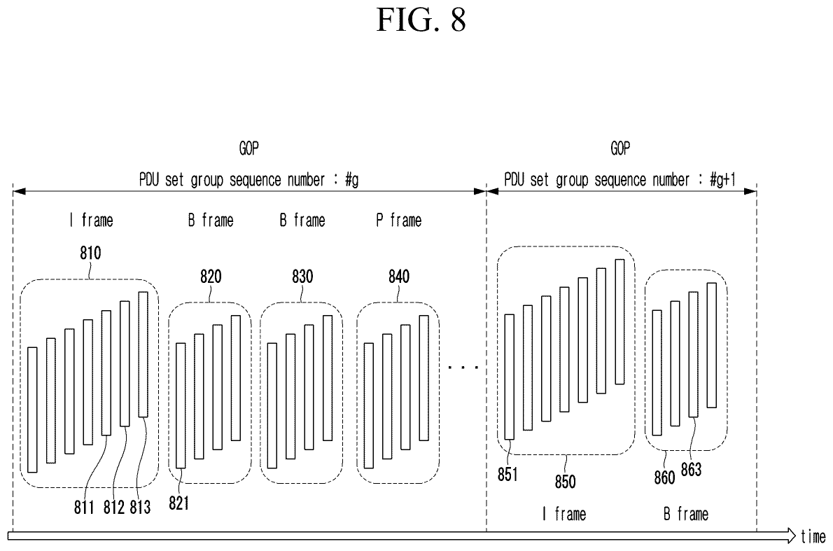

FIG. 8 is a conceptual diagram illustrating exemplary embodiments of PDU sets to which GTP-U extension headers are added.

The base station may transmit PDCP configuration information to the terminal. The transmission of the PDCP configuration information may be performed before receiving PDUs from the UPF entity or may be performed after receiving the PDUs. The PDCP configuration information may be transmitted through a radio resource control (RRC) reconfiguration message. The PDCP configuration information may include at least one of configuration information of a loss timer (e.g. t-reordering timer), information indicating transmission of a status report according to expiration of the t-reordering timer, or information indicating a discard operation based on a PDU set group. That is, transmission of a status report according to expiration of the t-reordering timer may be configured in the terminal by the PDCP configuration information. The loss timer may be used to determine whether a PDU transmitted from the base station to the terminal is lost. The PDCP configuration information may have abstract syntax notation (ASN) such as Table 1 and Table 2 below. When t-ReorderingTimeout_StatusReport is set to ‘true’, the terminal may transmit a status report to the base station according to expiration of the t-reordering timer. A PDCP entity may be configured in the terminal through the PDCP configuration information.

```
TABLE 1
PDCP-Config ::= SEQUENCE {
  ...
  t-Reordering ENUMERATE {ms0, ms1, ms2, ms4, ms5, ms8, ms10, ms15, ms20,
ms30, ms40, ms50, ms60, ms80, ms100, ms120, ms140, ms160, ms180, ms200, ms220,
ms240, ms260, ms280, ms300, ms500, ms750, ms1000, ms1250, ms1500, ms1750, ms2000,
ms2250, ms2500, ms2750, ms3000, spare28, spare27, spare26, spare25, spare24,
```

```
TABLE 2
  spare23, spare22, spare21, spare20, spare19, spare18, spare17, spare16, spare15,
spare14, spare13, spare12, spare11, spare10, spare09, spare08, spare07, spare06, spare05,
spare04, spare03, spare02, spare01}
    t-ReorderingTimeout_StatusReport ENUMERATED {true}
}
```

The terminal may receive the PDCP configuration information from the base station. The PDCP entity configured in the terminal based on the PDCP configuration information may receive PDUs from the base station. Each PDU received at the terminal may include a header (e.g. GTP-U header, GTP-U extension header, or GTP-U sub-header) including the PDU set information according to the exemplary embodiments illustrated in FIG. 7.

The PDCP entity of the terminal may receive a first PDU from the base station. The terminal may identify a sequence number (e.g. PDU sequence number) of the first PDU based on the PDU set information included in a GTP-U header of the first PDU. The terminal may identify that a second PDU having a sequence number smaller than the sequence number of the first PDU has not been received at the terminal. The terminal may start a t-reordering timer based on identifying that the second PDU has not been received at the terminal. During a time configured by the t-reordering timer, the terminal may perform a monitoring operation to receive the second PDU.

If the terminal receives the second PDU before the t-reordering timer expires, the t-reordering timer may be terminated. If the second PDU is not received at the terminal until the t-reordering timer expires, the terminal may determine that the second PDU is lost. In other words, the t-reordering timer may expire according to a result of the monitoring operation for receiving the second PDU at the terminal. After determining that the second PDU is lost, the terminal may transmit a status report for the second PDU to the base station. The status report may include information of the sequence number of the second PDU determined to be lost.

A PDCP entity of the base station may receive the status report for the second PDU from the PDCP entity of the terminal. The base station may determine that the second PDU is lost based on receiving the status report for the second PDU. The base station may identify a dependency parameter of the second PDU through a header (e.g. GTP-U header, GTP-U extension header, or GTP-U sub-header) of the second PDU. The base station may determine whether to discard the second PDU according to the dependency parameter of the second PDU. When the dependency parameter of the second PDU is 0, decoding failure of an entire GOP to which the second PDU belongs may be predicted due to the loss of the second PDU. Therefore, the base station may determine to discard the second PDU. When the base station determines to discard the second PDU, the base station may identify a PDU set group sequence number of a PDU set group to which the second PDU belongs through the PDU set information of the second PDU. The base station may discard one or more PDUs belonging to the PDU set group including the second PDU.

Referring to FIG. 8, PDUs, PDU sets, and PDU set groups transmitted by the base station or received at the terminal are illustrated. PDU set group sequence numbers of two PDU set groups may be #g and #g+1, respectively. PDU sequence numbers of PDUs 811, 812, 813, and 821 may be #n, #n+1, #n+2, and #n+3, respectively. Since the PDUs 811, 812, and 813 belong to an I-frame, dependency parameters of the PDUs 811, 812, and 813 may be 0. Since the PDU 821 belongs to a B-frame, a dependency parameter of the PDU 821 may be 1.

When the PDU 821 is received at the terminal, the terminal may identify that the PDU 813 has not been received. The terminal identifying that the PDU 813 has not been received may start a t-reordering timer. Until the t-reordering timer expires, the terminal may not receive the PDU 813. The terminal may transmit a status report for the PDU 813 to the base station. The base station that receives the status report may identify that the dependency parameter of the PDU 813 is 0. The base station may identify that a PDU set group sequence number of the PDU set group to which PDU 813 belongs is #g. The base station may discard one or more PDUs belonging to the PDU sets 810, 820, 830, and 840 belonging to the PDU set group having the PDU set group sequence number #g.

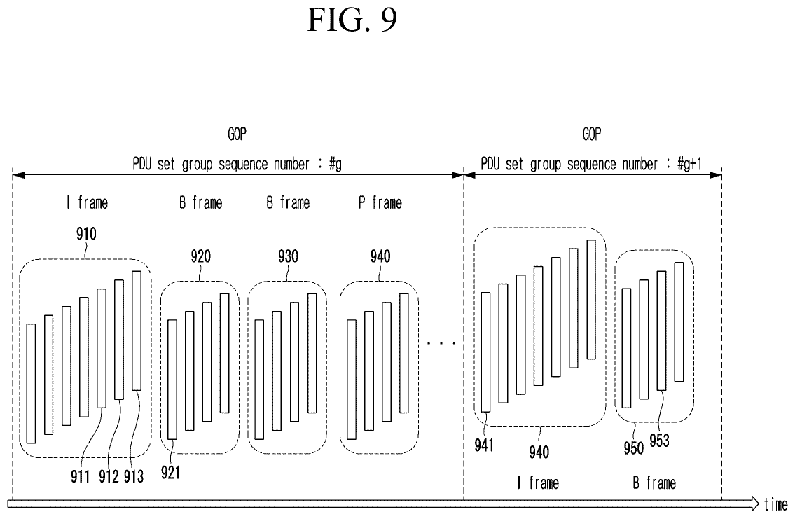

FIG. 9 is a conceptual diagram illustrating exemplary embodiments of PDU sets to which GTP-U extension headers are added.

The terminal may receive packets from the application layer or the service layer. A packet filtering layer of the terminal may perform filtering on the received packets. Through the packet filtering, the terminal may add at least one of an information element of a PDU set group sequence number, a dependency parameter, or an information element indicating presence of the dependency parameter/PDU set group sequence number in headers (e.g. GTP-U headers, GTP-U extension headers, or GTP-U sub-headers) of PDUs (or packets). Information elements added by the packet filtering layer of the terminal to the headers of PDUs may be information elements according to the exemplary embodiments illustrated in FIG. 7. An SDAP layer (or entity) of the terminal may receive SDAP SDUs from an upper layer (e.g. the packet filtering layer).

In another example, the terminal performing packet filtering through the packet filtering layer may add information elements according to the exemplary embodiments illustrated in FIG. 3 to headers of the received packets. The SDAP layer of the terminal may receive SDAP SDUs from an upper layer (e.g. the packet filtering layer). The SDAP layer of the terminal may generate SDAP PDUs by adding headers to the SDAP SDUs. The header added by the SDAP layer of the terminal may include an information element of a dependency parameter, an information element of a PDU set group sequence number, an information element indicating presence of the dependency parameter, or an information element indicating presence of the PDU set group sequence number. Alternatively, the SDAP layer of the terminal may generate PDU set information including at least one of the dependency parameter, the information element indicating presence of the PDU set group sequence number/dependency parameter, or the information element of the PDU set group sequence number, separately from the SDAP PDUs. The SDAP layer of the terminal may transmit at least one of the PDCP SDUs or the PDU set information to the PDCP layer (or entity) of the terminal.

The PDCP entity of the terminal may receive at least one of the PDCP SDUs or the PDU set information. The PDCP entity of the terminal may store at least one of the received PDCP SDUs or the PDU set information. The PDCP entity of the terminal may assign sequence numbers to respective PDCP SDUs. After assigning sequence numbers to the respective PDCP SDUs, the PDCP entity of the terminal may start a discard timer. During a time configured by the discard timer, the PDCP entity of the terminal may generate respective PDCP PDUs (e.g. a first PDCP PDU) by adding headers to the respective PDCP SDUs (e.g. a first PDCP SDU). The generated PDCP PDUs may be delivered to a lower layer (e.g. radio link control (RLC) layer or entity).

The RLC entity of the terminal may receive the first PDCP PDU. The RLC entity of the terminal receiving the first PDU may transmit a first report indicating that reception of the first PDCP PDU is successful to the PDCP entity of the terminal. The PDCP entity of the terminal receiving the first report within the time configured by the discard timer may stop the discard timer. The PDCP entity of the terminal stopping the discard timer may discard the stored first PDCP SDU.

The RLC entity of the terminal may fail to receive the first PDCP PDU. The RLC entity of the terminal that fails to receive the first PDCP PDU may fail to transmit the first report to the PDCP entity of the terminal. The PDCP entity of the terminal may fail to receive the first report within the time configured by the discard timer. When the PDCP entity of the terminal fails to receive the first report within the time configured by the discard timer, the discard timer may expire. When the discard timer expires, the PDCP entity of the terminal may determine loss of the first PDCP PDU. After determining the loss of the first PDCP PDU, the terminal may determine to discard the first PDCP SDU. The terminal may determine whether to discard PDCP SDUs belonging to a PDU set group to which the first PDCP SDU belongs, based on the dependency parameter included in the PDU set information or the dependency parameter included in the header of the first PDCP SDU. When the dependency parameter of the first PDCP SDU is set to 0, the PDCP entity of the terminal may identify a sequence number of the PDU set group to which the first PDCP SDU belongs. The terminal that identifies the sequence number of the PDU set group to which the first PDCP SDU belongs may determine to discard one or more PDCP SDUs belonging to the PDU set group to which the first PDCP SDU belongs. When the dependency parameter of the first PDCP SDU is set to 1, the PDCP entity of the terminal may not determine to discard one or more PDCP SDUs belonging to the PDU set group to which the first PDCP SDU belongs.

Referring to FIG. 9, PDCP SDUs, PDU sets, and PDU set groups delivered by the PDCP entity of the terminal are illustrated. Sequence numbers of two PDU set groups may be #g and #g+1, respectively. Sequence numbers of PDCP SDUs 911, 912, 913, and 921 may be #n, #n+1, #n+2, and #n+3, respectively. Since the PDCP SDUs 911, 912, and 913 belong to an I frame, dependency parameters of the PDCP SDUs 911, 912, and 913 may be 0. Since the PDCP SDU 921 belongs to a B frame, a dependency parameter of PDCP SDU 921 may be 1.

When an RLC entity of the terminal fails to receive a PDCP PDU generated based on the PDCP SDU 913, the RLC entity of the terminal may fail to transmit a report indicating that a PDCP PDU generated based on the PDCP SDU 913 has been received to the PDCP entity of the terminal. The PDCP entity of the terminal that fails to receive the report indicating that the PDCP PDU generated based on PDCP SDU 913 has been received within a time configured by a loss timer may identify the dependency parameter of the PDCP SDU 913. The PDCP entity of the terminal that identifies that the dependency parameter of PDCP SDU 913 is 0 may determine to discard the PDCP SDU 913. The PDCP entity of the terminal that determines to discard the PDCP SDU 913 may identify a PDU set sequence number of a PDU set sequence group to which the PDCP SDU 913 belongs. The PDCP entity of the terminal that identifies that the PDU set sequence number of the PDU set sequence group to which PDCP SDU 913 belongs is #g may discard one or more PDCP SDUs belonging to a GOP having the PDU set sequence number of #g.

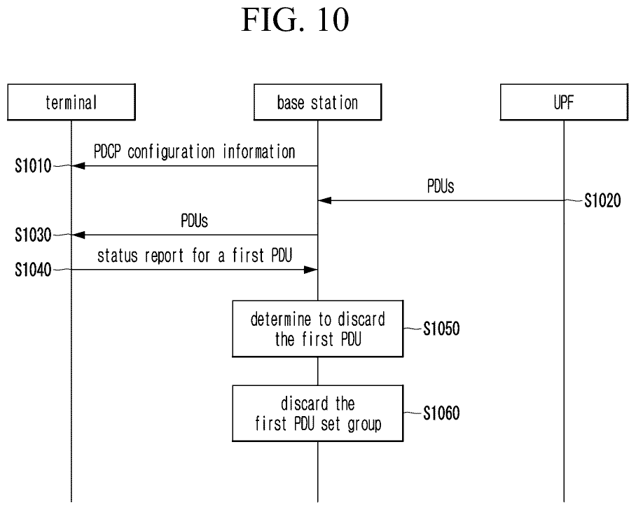

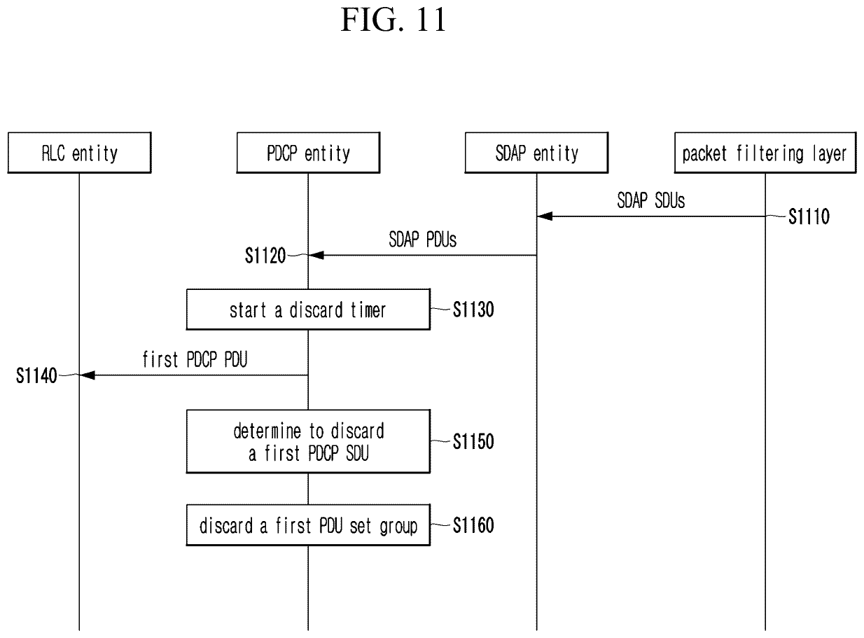

Procedures according to exemplary embodiments illustrated in FIG. 10 and FIG. 11 may correspond to procedures in which the exemplary embodiments illustrated in FIGS. 3 to 9 are summarized. Therefore, the exemplary embodiments illustrated in FIGS. 3 to 9 may be applied to the procedures according to the exemplary embodiments illustrated in FIG. 10 and FIG. 11.

FIG. 10 is a sequence chart illustrating exemplary embodiments of a PDU discarding procedure by a base station.

Referring to FIG. 10, a base station may transmit PDCP configuration information to a terminal (S1010). The PDCP configuration information may be the PDCP configuration information according to the exemplary embodiments illustrated in FIG. 8. After transmitting the PDCP configuration information to the terminal, the base station may receive PDUs from a UPF entity (S1020). Headers of the PDUs received at the base station may include information elements according to the exemplary embodiments illustrated in FIG. 7. After receiving the PDUs, the base station may transmit the PDUs to the terminal through QoS flows (S1030).

After receiving a first PDU belonging to the PDUs, the terminal may transmit a status report for the first PDU to the base station (S1040). The above status report may be the status report according to the exemplary embodiments illustrated in FIG. 8. After receiving the status report for the first PDU, the base station may determine loss of the first PDU. After determining loss of the first PDU, the base station may identify a dependency parameter of the first PDU. According to the dependency parameter of the first PDU, the base station may determine to discard the first PDU (S1050). After determining to discard the first PDU, the base station may identify a sequence number of a PDU set group to which the first PDU belongs. After identifying the sequence number of the PDU set group to which the first PDU belongs, the base station may discard one or more PDUs belonging to the PDU set group including the first PDU (S1060).

FIG. 11 is a sequence chart illustrating exemplary embodiments of an SDU discarding procedure by a terminal.

Referring to FIG. 11, a packet filtering layer of the terminal may deliver SDAP SDUs to an SDAP entity of the terminal (S1110). After receiving the SDAP SDUs, the SDAP entity of the terminal may generate SDAP PDUs. An SDAP PDU generation procedure may be the SDAP PDU generation procedure according to exemplary embodiments illustrated in FIG. 9. After generating the SDAP PDUs, the SDAP entity of the terminal may deliver the SDAP PDUs to a PDCP entity of the terminal (S1120). After receiving the SDAP PDUs (or PDCP SDUs), the PDCP entity of the terminal may assign sequence numbers to the respective PDCP SDUs (e.g. a first PDCP SDU). The PDCP entity of the terminal that has assigned a sequence number to the first PDCP SDU may start a discard timer (S1130).

During the time configured by the discard timer, the PDCP entity of the terminal may generate a first PDCP PDU by adding a header to the first PDCP SDU. After starting the discard timer, the PDCP entity of the terminal may deliver the first PDCP PDU to an RLC entity of the terminal (S1140). During the time configured by the discard timer, the PDCP entity of the terminal may fail to receive a report indicating reception of the first PDCP PDU from the RLC entity of the terminal. When the discard timer expires, the PDCP entity of the terminal may identify a dependency parameter of the first PDCP SDU. According to the dependency parameter of the first PDCP SDU, the PDCP entity of the terminal may determine to discard the first PDCP SDU (S1150). The PDCP entity of the terminal that determines to discarding the first PDCP SDU may identify a PDU set sequence group number of a PDU set sequence group to which the first PDCP SDU belongs. After identifying the PDU set sequence group number of the PDU set sequence group to which the first PDCP SDU belongs, the PDCP entity of the terminal may discard one or more PDCP SDUs belonging to the PDU set sequence group including the first PDCP SDU (S1160).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a base station, comprising:
receiving protocol data units (PDUs) from a user plane function (UPF) entity;
transmitting a first PDU belonging to the PDUs to a terminal;
receiving a status report associated with the first PDU from the terminal; and
discarding one or more PDUs belonging to a PDU set group including the first PDU based on the status report.

2. The method of claim 1, further comprising: transmitting packet data convergence protocol (PDCP) configuration information to the terminal before receiving the PDUS, wherein the PDCP configuration information includes at least one of: configuration information of a loss timer used for determining whether a PDU is lost or information indicating a discard operation based on a PDU set group.

3. The method of claim 1, wherein a header belonging to each of the PDUs includes PDU set information, and the PDU set information includes at least one of: identification information for each PDU set group to which each of the PDUs belongs, a dependency parameter of each of the PDUs, identification information for each PDU set to which each of the PDUs belongs, or information on a sequence number of each of the PDUs.

4. The method of claim 2, wherein the PDCP configuration information is transmitted through a radio resource control (RRC) reconfiguration message, and a header of the first PDU includes information on a sequence number of the first PDU.

5. The method of claim 1, wherein the status report includes at least one of information on a sequence number of the first PDU or information indicating loss of the first PDU.

6. The method of claim 1, wherein the discarding of the one or more PDUs comprises:
determining loss of the first PDU based on the status report;
determining whether to discard the first PDU based on a dependency parameter of the lost first PDU; and
discarding the one or more PDUs based on a result of the determining of whether to discard the first PDU.

7. The method of claim 2, wherein transmission of the status report according to expiration of the loss timer is configured for the terminal by the PDCP configuration information.

8. A method of a terminal, comprising:
receiving packet data convergence protocol (PDCP) configuration information from a base station;
after receiving the configuration information, receiving a first protocol data unit (PDU) from the base station;
starting a loss timer configured by the PDCP configuration information, based on determining that a second PDU associated with a sequence number smaller than a sequence number of the first PDU has not been received; and
transmitting a status report including the sequence number of the second PDU to the base station according to expiration of the loss timer.

9. The method of claim 8, wherein the PDCP configuration information includes at least one of: configuration information of the loss timer or information indicating a discard operation based on a PDU set group.

10. The method of claim 8, further comprising: performing a monitoring operation for receiving the second PDU during a time configured by the loss timer after starting the loss timer,
wherein the loss timer expires based on a result of the monitoring operation.

11. The method of claim 8, wherein the terminal is configured by the PDCP configuration information to transmit the status report according to expiration of the loss timer.

12. A base station comprising at least one processor, wherein the at least one processor causes the base station to perform:
receiving protocol data units (PDUs) from a user plane function (UPF) entity;
transmitting a first PDU belonging to the PDUs to a terminal;
receiving a status report associated with the first PDU from the terminal; and
discarding one or more PDUs belonging to a PDU set group including the first PDU based on the status report.

13. The base station of claim 12, wherein the at least one processor further causes the base station to perform: transmitting packet data convergence protocol (PDCP) configuration information to the terminal before receiving the PDUs,
wherein the PDCP configuration information includes at least one of: configuration information of a loss timer used for determining whether a PDU is lost or information indicating a discard operation based on a PDU set group.

14. The base station of claim 12, wherein a header belonging to each of the PDUs includes PDU set information, and the PDU set information includes at least one of: identification information for each PDU set group to which each of the PDUs belongs, a dependency parameter of each of the PDUs, identification information for each PDU set to which each of the PDUs belongs, or information on a sequence number of each of the PDUs.

15. The base station of claim 13, wherein the PDCP configuration information is transmitted through a radio resource control (RRC) reconfiguration message, and a header of the first PDU includes information on a sequence number of the first PDU.

16. The base station of claim 12, wherein the status report includes at least one of information on a sequence number of the first PDU or information indicating loss of the first PDU.

17. The base station of claim 12, wherein in the discarding of the one or more PDUs, the at least one processor causes the base station to perform:
determining loss of the first PDU based on the status report;
determining whether to discard the first PDU based on a dependency parameter of the lost first PDU; and
discarding the one or more PDUs based on a result of the determining of whether to discard the first PDU.

18. The base station of claim 12, wherein transmission of the status report according to expiration of the loss timer is configured for the terminal by the PDCP configuration information.
